(19) United States
(12) Patent Application Publication
(10) Pub. No.: US 2016/0253767 A1
(43) Pub. Date: Sep. 1, 2016

(54) Designing Wellbore Completion Intervals

(71) Applicant: HALLIBURTON ENERGY SERVICES, INC., Houston, TX (US)

(72) Inventors: Richard James Langenwalter, Lakewood, CO (US); Harold Grayson Walters, Tomball, TX (US)

(21) Appl. No.: 15/028,579

(22) PCT Filed: Nov. 11, 2013
(86) PCT No.: PCT/US2013/069498

§ 371 Date: Apr. 11, 2016

(51) Int. Cl. G06Q 50/02; G06Q 10/06; E21B 49/00; E21B 41/00; E21B 47/00

(52) U.S. Cl. CPC G06Q 50/02; E21B 41/0092; E21B 47/00; E21B 49/00; G06Q 10/0639; G06Q 10/067; E21B 43/16

(57) ABSTRACT

In some aspects, completion interval attributes are designed for wellbore intervals based on the stratigraphic positions of the respective wellbore intervals. The completion interval attributes can be determine by a completion design system that associates resource production attributes with distinct combinations of stratigraphic positions and completion interval attributes. In some aspects, the completion design system includes a correlation database generated by a correlation engine. The correlation engine can generate the correlation data based on production data and wellbore interval data from another wellbore.

### CROSS-REFERENCE TO RELATED APPLICATIONS

This application is a U.S. National Phase Application under 35 U.S.C. §371 and claims the benefit of priority to International Application Serial No. PCT/US2013/069498, filed on Nov. 11, 2013, the contents of which are hereby incorporated by reference.

### BACKGROUND

This specification relates to designing wellbore completion intervals.

After a wellbore is drilled in a subterranean region, a completion process is used to prepare the wellbore for production. The completion process may include fracture treatments, stabilization treatments, stimulation treatments, or other types of treatments applied to the subterranean region. The completion process may include installation of production tubing, inflow control devices, and other types of completion tools.

### DESCRIPTION OF DRAWINGS

FIG. 1 is a diagram of an example well system.

FIG. 2 is a diagram of an example computing system.

FIG. 3 is a diagram of an example system architecture for completion analysis and design.

FIG. 4 is a plot showing example correlation data derived from well system data.

Like reference symbols in the various drawings indicate like elements.

### DETAILED DESCRIPTION

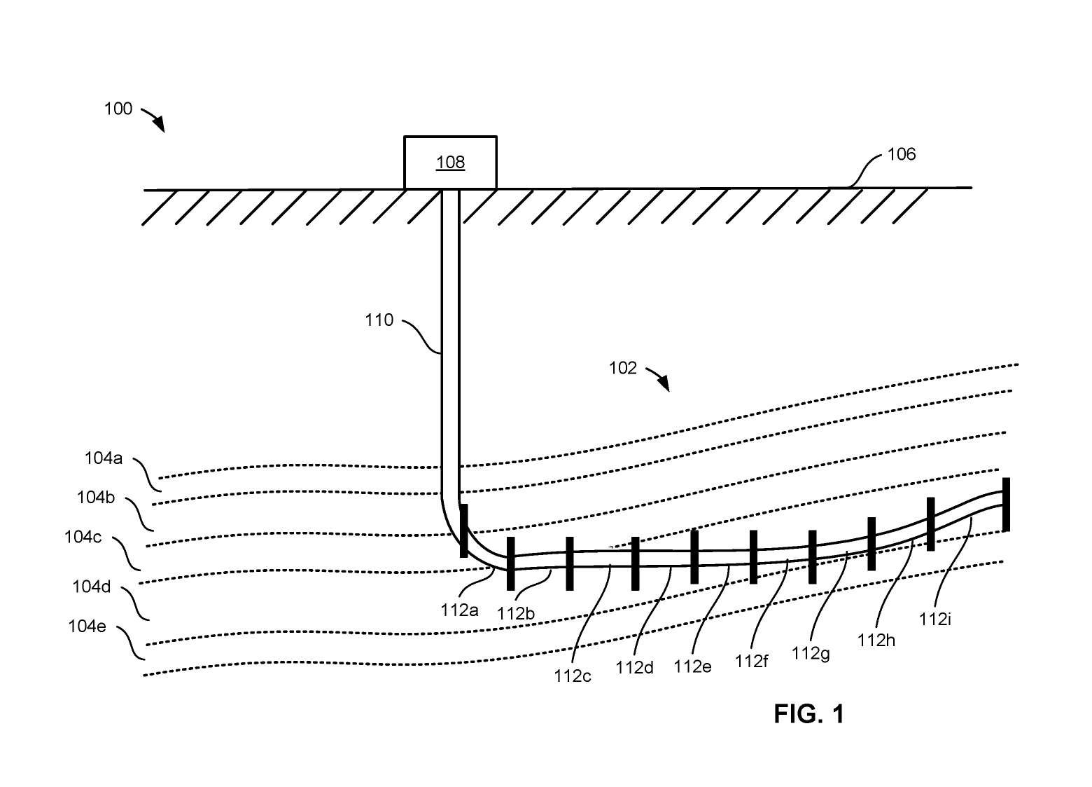

FIG. 1 is a diagram of an example well system 100. The example well system 100 includes a wellbore 110 defined in a subterranean region 102 beneath the ground surface 106. The example well system 100 includes surface equipment 108 at the surface 106. The well system 100 can include additional or different features, and the features of the well system 100 can be arranged as shown in FIG. 1, or the features of the well system 100 can be arranged in another manner. The example wellbore 110 shown in FIG. 1 includes a horizontal wellbore. A well system may include any combination of horizontal, vertical, slant, curved, or other wellbore orientations. Moreover, a well system may include multiple intersecting or non-intersecting wellbores.

The subterranean region 102 may include all or part of a rock formation (e.g., shale, coal, sandstone, granite, or others) that contain natural gas, oil, other hydrocarbons, or other materials of interest. The example subterranean region 102 shown in FIG. 1 includes a reservoir that contains hydrocarbon resources, such as oil, natural gas, other hydrocarbons, etc. The subterranean region 102 may include naturally fractured rock or natural rock formations that are not fractured to any significant degree. The subterranean region 102 may include tight gas formations that include low permeability rock (e.g., shale, coal, or others).

The example subterranean region 102 includes multiple subterranean layers 104a, 104b, 104c, 104d, 104e. In the example shown in FIG. 1, each subterranean layer represents a distinct stratigraphic position in the subterranean region 102. For example, each layer can have lithographic properties that are substantially uniform within the layer and distinct from adjacent layers. In some instances, a characteristic lithographic property of a subterranean layer includes the type of rock, the porosity of the rock, the fractured density of the rock, the hydrocarbon content of the rock, or other properties of the rock in the subterranean layer. For example, the subterranean layer 104d may include naturally fractured rock containing hydrocarbons, whereas the layers 104c and 104e may include a lower volume of hydrocarbons or lower density of natural fractures, etc.

As shown in FIG. 1, the example wellbore 110 includes multiple wellbore intervals 112a, 112b, 112c, 112d, 112e, 112f, 112g, 112h, 112i. A wellbore can include any number of wellbore intervals (e.g., 5, 10, 20, 30, 100, etc.), and the wellbore intervals can vary in length (e.g., 10 feet, 20 feet, 50 feet, etc.). In the example shown in FIG. 1 each wellbore interval is a distinct segment of the wellbore 110. The intervals may be defined by hardware installed in the wellbore 110, by the locations of perforations in the wellbore wall, or the intervals may be defined in another manner.

In some cases each interval includes one or more perforations, slots, or other means of connecting the wellbore to the reservoir. For example, the wellbore 110 may be cased or uncased, and the wellbore casing or the wellbore wall can be perforated for an injection treatment, stimulation treatment, production, or other activities. In some cases, each interval is defined by packers or seals at the intervals boundaries. For example, the first interval 112a may be defined by a set of packers at each end of the interval 112a, the second interval 112b be may be defined by a set of packers at each end of the interval 112b, etc.

Each of the wellbore intervals resides at a stratigraphic position in the subterranean region 102. The stratigraphic position can refer to the layer, or a property of the layer, in which the wellbore interval resides. In some examples, two or more intervals of a wellbore reside at different stratigraphic positions. In the example shown in FIG. 1, the interval 112a resides in the subterranean layer 104c, the interval 112b resides at the interface of the subterranean layers 104c and 104d, and the interval 112d resides in the subterranean layer 104d. In some cases, the stratigraphic position of a wellbore interval indicates the lithographic properties of the layer surrounding the wellbore interval, the distance between the wellbore interval an adjacent layer, or other information.

Each of the intervals in the wellbore can have distinct completion interval attributes. The completion interval attributes can include completion equipment, completion techniques or parameters thereof applied to the wellbore interval to prepare the interval for production. In some cases, all wellbore intervals have the same completion interval attributes. In some cases, some or all of the wellbore intervals are completed according to distinct completion interval attributes. The completion interval attributes for a given wellbore interval can be adapted or selected based on the stratigraphic position of the wellbore interval, production objectives, and other considerations.

The surface equipment 108 may include equipment installed above the surface 106 below the surface 106, for example, in the wellbore 110, and in other locations. The surface equipment 108 may include equipment for performing a treatment (e.g., a fracture treatment, a stabilization treatment, an acid treatment, etc.). At various times, the surface equipment 108 may include injection equipment, drilling equipment, production equipment, or other types of well system equipment; the surface equipment 108 may include logging systems, communication systems, systems for installing tools (e.g., production tools, injection tools, etc.) in the wellbore 100, or other types of systems. The surface equipment 108 may include measurement or observation equipment. For example, the surface equipment 108 can measure production attributes such as, for example, a volume of hydrocarbons produced from the wellbore 110, a rate of production from the wellbore 110, a fluid content produced from the wellbore 110, or other aspects of production. In some cases, the surface equipment 108 includes a computing system or a communication interface operable to receive data from and send data to a remote computing system.

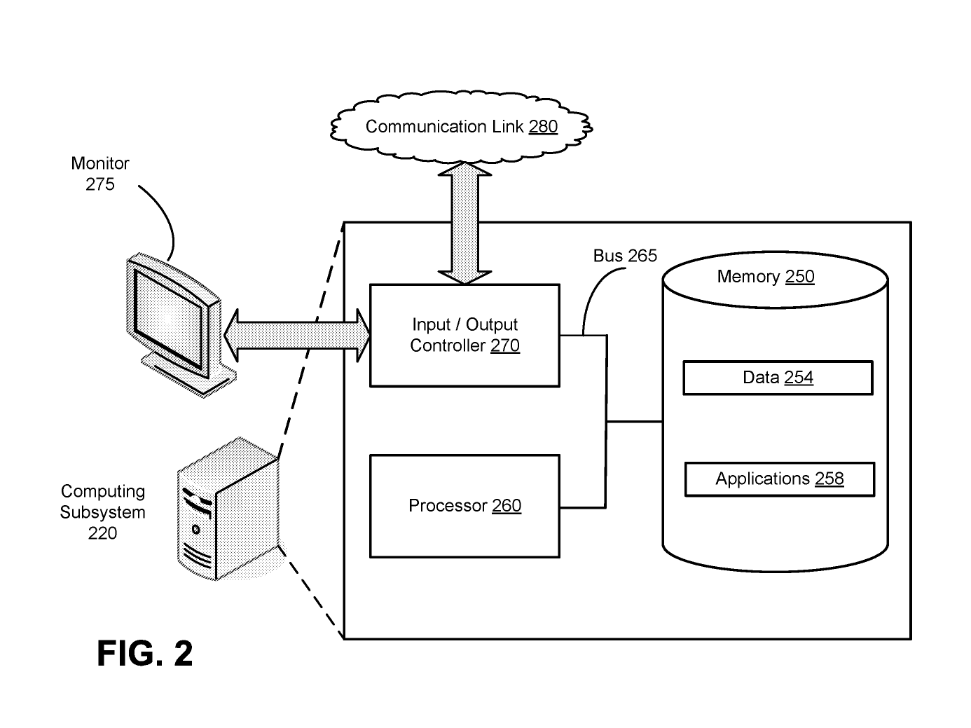

In some implementations, a completion design system is used to determine the completion interval attributes for each interval in the wellbore 110. The completion design system can be implemented by a computing system included in the well system 100 or in a remote location. For example, the completion design system can be implemented by the example computing system 200 shown in FIG. 2. The completion design system can receive wellbore interval data indicating the stratigraphic position of each respective wellbore interval 112a-112i, and the completion design system can select a type of treatment, parameters for a treatment, a type of completion equipment, parameters of completion equipment, or other completion attributes to be applied to each interval of the wellbore 110.

In some instances, production can be characterized by completion interval or producing interval position such that the optimum or desirable completion procedures and producing intervals can be more easily determined. The completion interval position can be tied to both the completion process attributes and resulting production. They may be correlated implicitly or explicitly through the use of various data mining and analysis techniques. The correlations may be derived based on data, from either actual or model treatments, that include hydraulic fracturing data, petrophysical calculations, relative stratigraphic wellbore positions, geologic analysis, and other data. The petrophysical calculations may include, for example, total oil content, natural fracture density, effective porosity, effective permeability, or other properties.

The stratigraphic position (or lithographic properties associated with the stratigraphic position) of each wellbore interval can be detected by logging equipment, derived from computer simulations, derived from geological data analysis, or from other sources. In some examples, the stratigraphic position of each wellbore interval includes lithographic information obtained from logging while drilling, measurement while drilling, wireline logging, seismic monitoring, micro seismic monitoring, or other types of observation. The stratigraphic position of the wellbore interval can be based on nuclear magnetic resonance logging, resistivity logging, gamma logging, acoustic logging, and other types of logging.

In some instances completion interval attributes are determined based on attribute weighted averages. For example, values for one or more variables can be identified for each individual wellbore interval. The variables can include production attributes or other types of variables. The values of the variables may be determined discretely at a point in the wellbore or over the intersection links of the wellbore in the reservoir producing interval in which it is contained. The appropriate variables and weighting factors could be determined a priori based on engineering expertise, as a result of data mining, as a result of data analysis, or based on other factors.

The completion design system can account for the spatial relationship between completion interval stratigraphic position, completion interval sequence, producing interval position, or a combination of these and other completion attributes, and the resulting production. Production attributes can be associated with individual wellbore intervals, and by identifying correlations between the production attributes and completion interval attributes, completion interval attributes can be optimized for varying interval stratigraphic positions. As such, the completion design system can provide a more predictable correlation between production and completion and reservoir attributes which can be valuable in a production workflow.

The completion design system can design completion interval attributes based on a correlation database. The correlation database can be derived from historical production data and stratigraphic information associated with wellbore intervals. The correlation data can be generated by, for example, by a correlation engine that identifies trends in the historical production data, stratigraphic information, and associated completion attributes. For example, the correlation engine may determine that more extensive hydraulic fracturing in a low-permeability region may generally correlate with higher production, or the correlation engine may determine a type of hydraulic fracturing that correlates with higher production from zones with a particular permeability or fracture density. As another example, the correlation engine may determine that hydraulic fracturing near a reservoir boundary has less benefit than hydraulic fracturing in the center of the reservoir; or the correlation engine may determine a type of production equipment the correlates with higher production from zones with a particular fluid content.

FIG. 2 is a diagram of an example computing system 200. The example computing system 200 can operate in connection with a well system or independent of a well system. For example, the computing system 200 can be located at or near one or more wells of the well system or at a remote location apart from a well system. In some implementations, communication links allow the computing system 200 to communicate with a well system. In some instances, the computing system 200 can receive data from a well system, analyze the data, and send an output to the same well system or another well system.

The example computing system 200 includes a memory 250, a processor 260, and input/output controllers 270 communicably coupled by a bus 265. The memory 250 can include, for example, a random access memory (RAM), a storage device (e.g., a writable read-only memory (ROM) or others), a hard disk, or another type of storage medium. The computing system 200 can be preprogrammed or it can be programmed (and reprogrammed) by loading a program from another source (e.g., from a CD-ROM, from another computer device through a data network, or in another manner). In some examples, the input/output controller 270 is coupled to input/output devices (e.g., a monitor 275, a mouse, a keyboard, or other input/output devices) and to a communication link 280. The input/output devices can receive or transmit data in analog or digital form over communication links such as a serial link, a wireless link (e.g., infrared, radio frequency, or others), a parallel link, or another type of link.

The communication link 280 can include any type of communication channel, connector, data communication network, or other link. For example, the communication link 280 can include a wireless or a wired network, a Local Area Network (LAN), a Wide Area Network (WAN), a private network, a public network (such as the Internet), a WiFi network, a network that includes a satellite link, or another type of data communication network.

The memory 250 can store instructions (e.g., computer code) associated with an operating system, computer applications, and other resources. The memory 250 can also store application data and data objects that can be interpreted by one or more applications or virtual machines running on the computing system 200. As shown in FIG. 2, the example memory 250 includes data 254 and applications 258. The data 254 can include wellbore interval data, completion interval attribute data, production data, correlation data, or other types of data. In some implementations, a memory of a computing device includes additional or different data, applications, or other information.

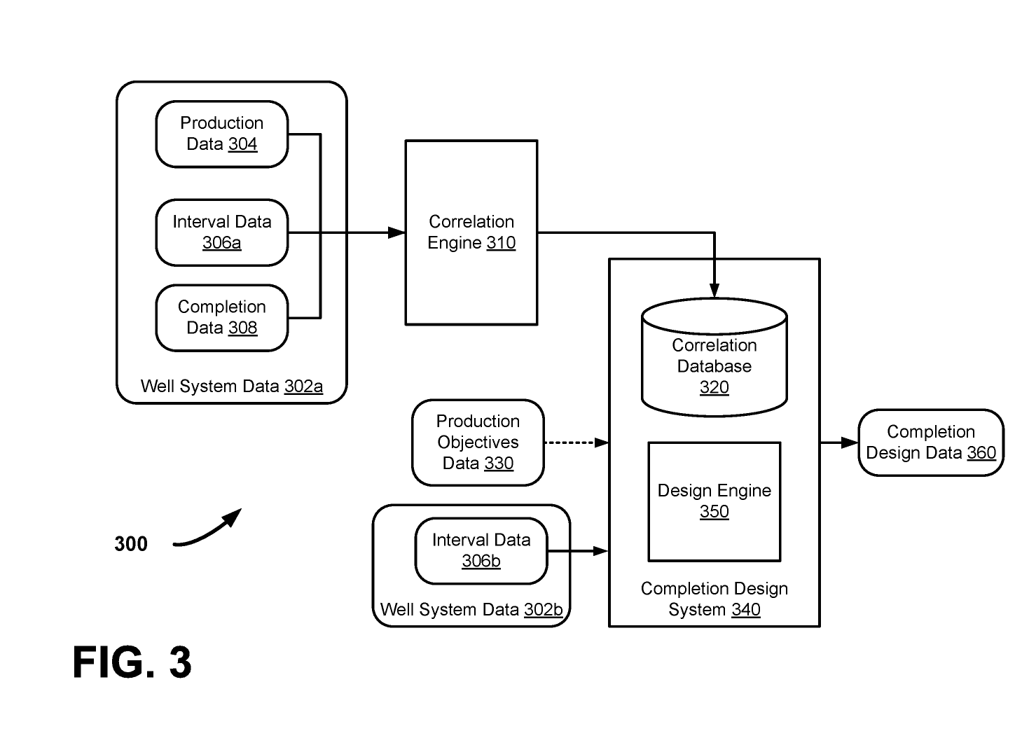

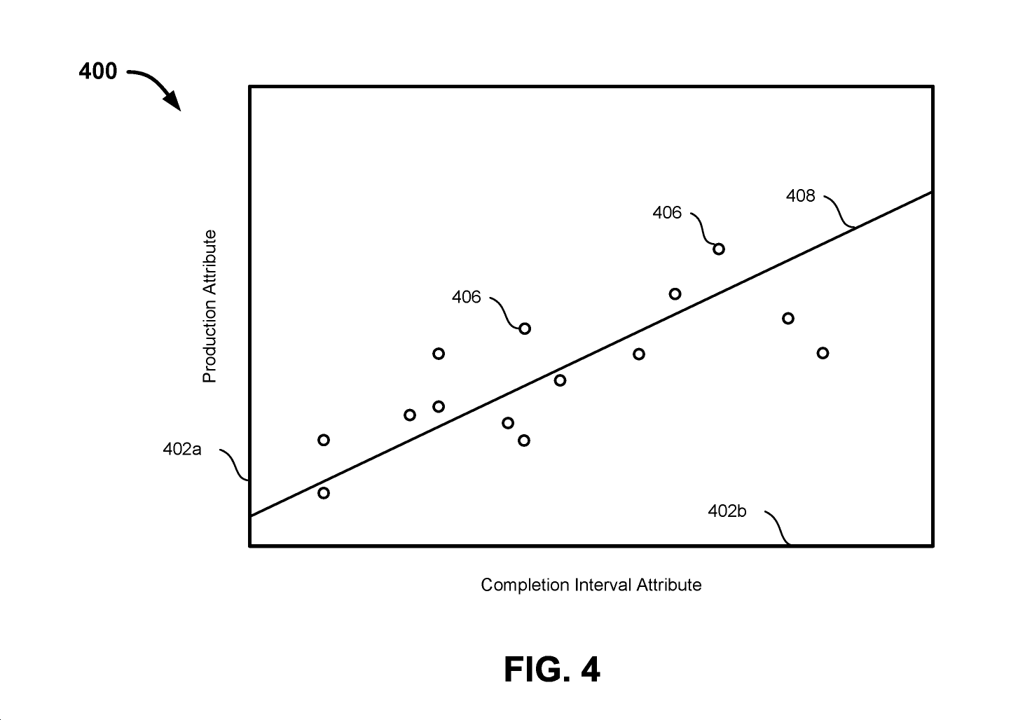

The applications 258 can include software applications, scripts, programs, functions, executables, or other modules that are interpreted or executed by the processor 260. For example, the applications 258 can include a correlation engine, a completion design engine, or other types of applications. The applications 258 may include machine-readable instructions for performing one or more of the operations related to FIG. 3, or other operations. The applications 258 may include machine-readable instructions for generating a user interface or a plot, for example, as shown in FIG. 4. The applications 258 can receive input data, such as wellbore interval data, production data, or other types of input data, from the memory 250, from another local source, or from one or more remote sources (e.g., via the communication link 280). The applications 258 can generate output data and store the output data in the memory 250, in another local medium, or in one or more remote devices (e.g., by sending the output data via the communication link 280).

The processor 260 can execute instructions, for example, to generate output data based on data inputs. For example, the processor 260 can run the applications 258 by executing or interpreting the software, scripts, programs, functions, executables, or other modules contained in the applications 258. The processor 260 may perform one or more of the operations related to FIG. 3. The input data received by the processor 260 or the output data generated by the processor 260 can include any of the correlation data, wellbore interval data, production data, etc.

FIG. 3 is a diagram of an example system architecture 300 for completion analysis and design. All or part of the architecture 300 can be implemented in a well system, a computing system, or a combination of these and other types of systems. For example, the architecture 300 can include features of the example well system 100 shown in FIG. 1, features of the example computing system 200 shown in FIG. 2, or a combination of multiple different systems distributed at multiple different locations.

The example architecture 300 shown in FIG. 3 includes well system data 302a, well system data 302b, a correlation engine 310, a completion design system 340, and a completion design data 360. A completion analysis and design system can include additional or different features, and the features of the completion analysis and design system can operate as shown and described with respect to FIG. 3 or in another manner.

The example well system data 302a includes production data 304, interval data 306a, and completion data 308. The well system data 302a may include additional or different data. The well system data 302a can include information describing an existing well system, a simulated well system model, a planned well system, or another type of well system data. In some examples, the well system data 302a includes information obtained by measurements on site at a well system such as, for example, the well system 100 shown in FIG. 1. In some examples, the well system data 302a includes information generated by a computing system that models, simulates, or analyzes well system data such as, for example, the computing system 200 shown in FIG. 2.

The well system data 302a can include information describing multiple intervals from a single well or from multiple different wells. In some implementations, the well system data 302a are taken from multiple wellbores or multiple well systems, and the correlation engine 310 can use the well system data 302a to develop correlations across a range of wellbores or well systems at the same time. For example, the well system data 302a may include a wide range of completion attributes, production attributes, stratigraphic attributes, and other properties.

In the example shown in FIG. 3, the well system data 302a are from a first set of wells, and the well system data 302b are from another set of wells. According to the example system architecture 300 shown in FIG. 3, the well system data 302a from the first set of wells are used to generate correlation data for the correlation database 320, and the correlation data are then used with the well system data 302b from the second set of wells to optimize or improve the completion attributes for the second set of wells. The first and second sets of wells can be part of the same well system, or they may be part of multiple different well systems.

The production data 304 can include information associated with producing subterranean resources from the first set of wells. The production data 304 can describe production attributes for an overall well system, for an individual wellbore, for individual wellbore intervals, or for other aspects of the first set of wells. The production data 304 can indicate a volume of fluids produced, a rate at which fluids are produced, net or gross value of resources produced, profitability of the wellbore, the duration of production activities, a fluid content produced, or other types of information. The production data 304 can include measured or estimated resource production history data from an existing well system, a simulated resource production history from a computer model of well system, or a combination of these and other information.

The interval data 306a can include information describing the distinct intervals of the first set of wells. For example, the interval data 306a may indicate the length and size of each wellbore interval, the stratigraphic position of each wellbore interval, or other properties of each wellbore interval. In some cases, the stratigraphic position of the wellbore interval indicates the lithographic properties of rock surrounding the wellbore interval, the lithographic properties of the subterranean layer in which the interval resides, the lithographic properties of subterranean layers near or adjacent to the wellbore interval, or combination of these and other attributes.

The completion data 308 can include information describing attributes of the completion of the first set of wells. The completion data 308 may indicate distinct completion attributes for each wellbore interval, completion attributes for an overall wellbore or well system, or both. In some cases, the completion data 308 indicate a type of injection treatment used, a type of stimulation treatment used, a type of fracture treatment used, a type of completion hardware installed, a configuration of hardware installed, or information on other activities applied to a wellbore or wellbore interval before producing the wellbore. The completion data 308 may indicate a sequence of multiple treatments applied to each wellbore interval or an order in which the wellbore intervals were treated.

The example correlation engine 310 can be implemented by hardware, software, firmware, or combination thereof In some cases, the correlation engine 310 is implemented by one or more software programs running on a computer system. The example correlation engine 310 receives some or all of the well system data 302a as input and produces outputs that include correlation data. For example, the inputs can include the production data 304, the interval data 306a, the completion data 308, or a combination of these and other data; and the correlation data and possibly other outputs generated by the correlation engine 310 can be used to update the correlation database 320.

In some example implementations, the correlation engine 310 analyzes the input data to identify correlations. The correlations detected by the correlation engine 310 can include trends or other types of relationships garnered through analysis of the well system data 302a, or other types of correlations. For example, the correlation engine 310 may perform data mining, data searching, data fitting, or other types of data analysis. In some cases, the correlation engine 310 examines production data associated with distinct combinations of completion attributes and stratigraphic attributes of individual wellbore intervals. For example, the correlation engine 310 may determine completion attributes that optimize or otherwise improve production for various stratigraphic positions in a subterranean region.

In some implementations, the correlation data indicate the presence of a relationship among two, three, or more variables analyzed by the correlation engine 310. In some instances, the correlation data indicate a trend (or parameters of a trend) in the relationship among the variables. In some cases, the variables can include binary indicators, values of measurements obtained in a well system, values derived from simulations of a model well system, or other types of variables. The correlations can be stored as links or associations between two or more of the variables.

In some cases, the correlation engine 310 assimilates production data and completion data associated with wellbore intervals that have the same (or related) stratigraphic positions. The assimilated data can include data associated with wellbore intervals from a single wellbore, multiple wellbores in a single well system, or multiple wellbores in multiple well systems. The correlation engine 310 can analyze the assimilated data to determine completion attributes that improve or optimize production for the stratigraphic positions of the wellbore intervals for which data was assimilated. In some instances, the correlation engine 310 may identify a relationship or trend in the assimilated data. For example, the correlation engine 310 may determine that increasing the fluid density of injected fluid leads to an increased production volume, that decreasing the fluid density of injected fluid leads to increased production volume, that increasing the duration of the stimulation treatment leads to improved production, that decreasing the duration of the stimulation treatment leads to improve production, or other types of trends.

The correlation engine 310 may determine ideal, optimal, acceptable, or otherwise desirable completion attributes for wellbore intervals having a range of stratigraphic properties. For example, the correlation engine 310 may determine that injecting a particular type of treatment fluid at a particular rate or pressure or in a particular manner may correlate with optimal results for wellbore intervals having certain stratigraphic positions. The correlation engine 310 may determine relationships between completion attributes and production attributes for particular wellbore intervals having certain stratigraphic positions. For example, the correlation engine 310 may identify a “sweet spot” for fluid pressures during a fracture treatment.

In some instances, the correlation engine 310 determines parameters of a functional relationship between completion attributes and production attributes for one or more stratigraphic positions. For example, the correlation engine 310 may determine parameters of a linear relationship, an exponential relationship, an inverse relationship, a polynomial relationship, or another type of functional relationship. For example, the correlation engine 310 may identify the slope of a linear curve, the inflection point of the polynomial curve, a rate of an exponential increase or decrease, or another parameter. The correlation engine 310 may employ other types of sophisticated modeling and analytic techniques to arrive at the relationships among completion attributes, production attributes, and stratigraphic positions.

The correlation data produced by the correlation engine 310 can include tables, lists, records, or other types of data structures indicating the correlations detected by the correlation engine 310. For example, the correlation data can be structured as a table indexed by stratigraphic properties, completion attributes, production objectives, or a combination of these and other indices. In some instances, the correlation data indicates one or more completion interval attributes that are correlated with improved or optimal production from an interval having a specified type or range of stratigraphic properties. The correlation data can be stored in the correlation database 320, or the correlation data can be used to update existing correlation data previously stored in the correlation database 320.

The well system data 302b can include information on each of the wellbore intervals in the second set of wells. In some examples, the second set of wells is a more-recently drilled wellbore where production has not begun, a wellbore to be modeled in a computer simulation, or another type of wellbore. Generally, the well system data 302b can describe wellbore intervals in any type of wellbore, in multiple wellbores, in multiple well systems, etc. In some instances, the correlation data generated from the well system data 302a can be used to design a completion that will improve or optimize production from the wellbore intervals described by the well system data 302b.

The completion design system 340 shown in FIG. 3 includes the correlation database 320 and the design engine 350. The completion design system 340 may include additional or different features, and the features of the completion design system may operate as shown and described with respect to FIG. 3 or in another manner. As shown in FIG. 3, the completion design system 340 receives inputs that may include interval data 306b, production objective data 330, and possibly additional information; the completion design system 340 generates outputs that include completion design data 360 and possibly additional information.

The completion design system 340 can be implemented by hardware, software, firmware, or combination thereof. For example, the correlation database 320 can be implemented in memory, on a server, in a software program, or in another manner; the design engine 350 can be implemented as a software program running on a computing system, or in another manner. The completion design system 340 can receive inputs from a local memory or from a remote source or a combination thereof, and the completion design system 340 can store outputs on a local memory or send outputs to remote destination or another computing system.

Similar to the interval data 306a for the first set of wells, the interval data 306b for the second set of wells can indicate the length and size of each wellbore interval, the stratigraphic position of each wellbore interval, or other properties of each wellbore interval. The design engine 350 can receive the wellbore interval data 306b and determine completion interval attributes for one or more of the wellbore intervals. The design engine 350 can determine the completion interval attributes by selecting the completion interval attributes that optimize resource production for an individual wellbore interval or an overall wellbore or well system. In some instances, the design engine 350 queries the correlation database 320 based on wellbore interval data, production objectives, or other information.

In some examples, the design engine 350 determines a stratigraphic position of the wellbore interval and queries the correlation database 320 based on the stratigraphic position, lithographic properties of the stratigraphic position, or other information. In response to receiving the query, the correlation database 320 can compare the stratigraphic position, the lithographic properties, or the other information received from the design engine 350 against an index or field in the correlation database 320. Based on the comparison, the correlation database 320 can return one or more records, lists, or tables to the design engine 350. The design engine 350 can use the records, lists, or tables returned by the correlation database 320 to determine the completion interval attribute for the stratigraphic position of the wellbore interval.

The design engine 350 can query the correlation database 320 for a single wellbore interval or multiple wellbore intervals and determine completion interval attributes for a single wellbore interval or multiple wellbore intervals. The completion design system 340 can combine the completion interval attributes for one or more wellbore intervals in a single wellbore or multiple wellbores in a well system, and generate completion design data 360. The completion design data 360 can indicate the completion attributes selected by the design engine 350 to optimize or otherwise improve production of resources from the well system.

In some cases, the design engine consults the production objectives data 330 to determine the optimal completion attributes for one or more wellbore intervals, for one or more wellbores, or for a well system. For example, the production objective data 330 may indicate the desired production volume for a well system, a desired maximum cost for the well system, a minimum profitability for the well system, a desired hydrocarbon content for the well system, or a combination of these and other types of production objectives. In some cases, the design engine 350 assumes production objectives or assumes an optimal production objective and generates the completion design based on the assumed objectives. For example, the design engine 350 may assume that the production objectives include producing the maximum volume of hydrocarbons from the wellbore, maximizing profitability of the wellbore, maximizing the lifetime of the wellbore, or other objectives.

The completion design engine 350 can be configured to improve or optimize production for a wellbore, a well system, a production zone, or another system. In some instances, the completion design engine 350 selects completion interval attributes that optimize a local resource production attribute for an individual wellbore interval. In some instances, the completion design engine 350 selects completion interval attributes that optimize resource production across multiple wellbore intervals.

To optimize with respect to multiple wellbore intervals, the design engine 350 can use weighted averages or weighted distributions over the wellbore intervals. For example, the design engine 350 can assign a weight to each respective wellbore interval along the wellbore or along multiple wellbores. The weight for each wellbore interval may be selected based on the size, location, or properties of each interval. For example, intervals near the heel of a horizontal wellbore may be given a higher or lower weight than intervals near the toe of the horizontal wellbore. As another example, longer intervals may be given a higher or lower weight than smaller intervals. The design engine 350 can select completion interval attributes that optimize or otherwise improve a weighted sum of production attributes. For example, the production contribution from each interval can be scaled by the weight assigned to that interval.

The completion design data 360 can be used to complete an existing wellbore, to simulate completion and production of a well system, or for other purposes. For example, if the completion design data 360 specifies a particular injection treatment to be applied in one or more wellbore intervals, an injection system can be programmed to apply the specified injection treatment to the specified wellbore intervals. As another example, if the completion design data 360 specifies a particular type of inflow control device, production tubing, or other hardware to be included in a wellbore interval completion, the specified hardware can be installed in the specified wellbore intervals.

In some implementations, the system architecture 300 uses multiple data sources, modeling programs, and other resources to develop the correlations, to develop completion designs, or for other purposes. For example, the correlation engine 310, the design engine 350, or other components of the system architecture 300 may access treatment data, geological data, fracture data, fluid data, flow models, complex fracture models, reservoir models, wellbore models, fluid flow simulators, injection treatment simulators, reservoir simulators, or a combination of these and other data or applications.

In some implementations, the system architecture 300 can access or generate treatment data that indicate a pumping schedule, injection treatment parameters (e.g., information on flow rates, flow volumes, slurry concentrations, fluid compositions, injection locations, injection times, or other parameters), or other treatment data. The system architecture 300 may obtain geological data relating to geological properties of a subterranean region, such as, for example, information on the lithology, fluid content, stress profile (e.g., stress anisotropy, maximum and minimum horizontal stresses), pressure profile, spatial extent, porosity, or other attributes of reservoir media. The geological data can include information collected from well logs, rock samples, outcroppings, microseismic imaging, or other data sources. The system architecture 300 may obtain fracture data that identify the locations, sizes, shapes, and other properties of fractures in a subterranean region. The fracture data can include information on natural fractures, hydraulically-induced fractures, or any other type of discontinuity in the subterranean region. The fracture data can include fracture planes calculated from microseismic data or other information. The system architecture 300 may obtain fluid data that indicate types of fluids, fluid properties, thermodynamic conditions, and other information related to well system fluids. The system architecture 300 can use these and other data to operate computer models or simulations, to generate correlation data or completion designs, or for other purposes.

FIG. 4 is a plot 400 showing an example of correlation data from a well system. The example plot 400 includes a vertical axis 402a representing a range of production attributes and a horizontal axis 402b representing a range of completion interval attributes. The plot 400 also includes data points 406 and a trend line 408. In the example shown, each data point 406 represents a production attribute value associated with the completion interval attribute value, and the trend line 408 represents a linear fit of the data points 406.

The completion interval attribute (represented by the horizontal axis 402b) can relate to a parameter of a treatment applied to a wellbore interval such as, for example, a parameter of a fracture treatment, stimulation treatment, stabilization treatment, or another type of treatment. The completion interval attribute can relate to a parameter of completion hardware installed in a wellbore interval such as, for example, a parameter of an inflow control device, a size of a sand screen, a size of production tubing, or another type of hardware parameter. The production attribute (represented by the vertical axis 402a) can relate to a parameter of production history associated with the wellbore. For example, the production attribute can include volume produced, rate of production, profitability, production cost, production lifetime, or a combination of these and other parameters.

As an example, the data points 406 in the plot 400 may represent data from multiple wellbore intervals that all have a common stratigraphic property. For example, the data points 406 may represent wellbore intervals in rock formations having permeability or porosity in a specified range. The horizontal axis 402b may represent the fracturing pressure used to fracture the wellbore interval, and the vertical axis 402a may represent the production volume from the wellbore that included the wellbore interval. The trend line 408 in the example shown in FIG. 4 suggests that increased fracture pressure correlates with increased production volume for the range of values shown in the plot 400.

In the example shown in FIG. 4, the trend line 408 is an example of a correlation derived by a linear fit of multiple data points. Correlations can be derived by other techniques. For example correlations can be derived from other types of data fitting, data binning, or other techniques. In some instances, a histogram can be constructed from production data and completion data for wellbore intervals associated with a common stratigraphic property, and one or more optimal values can be derived from the histogram.

In some implementations, each value along the horizontal axis 402b can represent a distinct combination of completion interval attributes and stratigraphic positions, and each value along the vertical axis 402a can represent a distinct production attribute. The data in the plot 400 can be processed to correlate the resource production attributes with the distinct combinations of completion interval attributes and stratigraphic positions. For example, processing the data in the plot may include fitting the data, identifying maxima, minima, inflection points, matching the data to a model, or performing other types of analysis.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks , and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system can be or include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of examples have been described. Nevertheless, it will be understood that various modifications can be made. Accordingly, other implementations are within the scope of the following claims.

1. A method of analyzing well system completions, the method comprising:
receiving resource production data associated with producing resources from a subterranean region through multiple distinct wellbore intervals;
receiving wellbore interval data indicating respective stratigraphic positions and completion interval attributes of the respective wellbore intervals; and
processing the resource production data and the wellbore interval data to correlate resource production attributes with distinct combinations of completion interval attributes and stratigraphic positions.

2. The method of claim 1, further comprising generating a correlation database that indicates relationships between the resource production attributes and the distinct combinations of completion interval attributes and stratigraphic positions.

3. The method of claim 1, wherein the wellbore interval data comprise information on multiple wellbores, and the resource production data comprise information on resource production history from the multiple wellbores.

4. The method of claim 1, wherein the wellbore interval data comprise information on a model for multiple wellbores, and the resource production data comprise information on simulated resource production history the model.

5. The method of claim 1, wherein the resource production data indicate at least one of production volume, production rate, production cost, or profitability associated with producing resources from the subterranean region through the wellbore intervals.

6. The method of claim 1, wherein the completion interval attribute of each wellbore interval comprises at least one of:
a type of treatment applied to the wellbore interval;
a sequence of treatments applied to the wellbore interval; or
a type of completion hardware installed in the wellbore interval.

7. The method of claim 1, wherein the stratigraphic position of each wellbore interval indicates a lithographic property of a subterranean layer associated with the wellbore interval.

8. A method of designing a completion for a well system in a subterranean region, the method comprising:
identifying stratigraphic positions of respective wellbore intervals in a subterranean region, at least two of the wellbore intervals residing in different stratigraphic positions in the subterranean region; and
determining completion interval attributes for the respective wellbore intervals based on the stratigraphic positions of the respective wellbore intervals, the completion interval attributes being determined by a completion design system that associates resource production attributes with distinct combinations of stratigraphic positions and completion interval attributes.

9. The method of claim 8, wherein the completion design system determines the completion interval attributes by selecting a completion interval attribute that satisfies a resource production objective for the well system.

10. The method of claim 8, wherein the completion design system determines the completion interval attributes by selecting a completion interval attribute that optimizes a local resource production attribute for each wellbore interval.

11. The method of claim 8, wherein the completion design system determines the completion interval attributes by:
assigning weights to the respective wellbore intervals along a wellbore; and
selecting completion interval attributes that optimizes an overall resource production attribute for the wellbore based on a weighted average across the wellbore intervals.

12. The method of claim 8, further comprising generating a completion design for the well system, the completion design indicating the completion interval attributes determined for the respective wellbore intervals.

13. The method of claim 8, wherein determining a completion interval attribute comprises determining at least one of:
a type of treatment for the wellbore interval;
a sequence of treatments for the wellbore interval; or
a type of completion hardware for the wellbore interval.

14. The method of claim 8, wherein the stratigraphic position of each wellbore interval indicates a lithographic property of a subterranean layer associated with the wellbore interval.

15. A system comprising:
a correlation database that stores correlation data for well systems, the correlation data indicating correlations between resource production attributes and distinct combinations of completion interval attributes and stratigraphic positions; and
a completion design engine operable to:
identify stratigraphic positions of respective wellbore intervals in a subterranean region;
access correlation data from the correlation database based on the stratigraphic positions of the respective wellbore intervals; and
determine completion interval attributes for the respective wellbore intervals based on the correlation data.

16. The system of claim 15, further comprising a correlation engine operable to generate the correlation data, the completion design engine being operable to determine the completion interval attributes for a first wellbore, the correlation engine being operable to generate the correlation data based on production data and wellbore interval data from multiple other wellbores.

17. The system of claim 16, wherein the correlation engine is operable to:
receive resource production data associated with producing resources through wellbore intervals in the other wellbores;
receive wellbore interval data indicating respective stratigraphic positions and completion interval attributes for the respective wellbore intervals in the other wellbores; and
generate the correlation data, based on the resource production data and the wellbore interval data, by correlating resource production attributes with distinct combinations of completion interval attributes and stratigraphic positions.

18. The system of claim 15, wherein the completion design engine is operable to determine the completion interval attributes by selecting a completion interval attribute that optimizes a local resource production attribute for each wellbore interval.

19. The system of claim 15, wherein the completion design engine is operable to determine the completion interval attributes by:
assigning weights to the respective wellbore intervals along a wellbore; and
selecting completion interval attributes that optimizes an overall resource production attribute for the wellbore based on a weighted average across the wellbore intervals.

20. The system of claim 15, wherein the completion design engine is operable to generate a completion design for the wellbore, the completion design indicating the completion interval attributes determined for the respective wellbore intervals.
